(19) United States
(12) Patent Application Publication
(10) Pub. No.: US 2006/0292297 A1
(43) Pub. Date: Dec. 28, 2006

(54) Patterning CNT emitters

(75) Inventors: Dongsheng Mao, Austin, TX (US); Richard Fink, Austin, TX (US); Zvi Yaniv, Austin, TX (US)

Correspondence Address: WINSTEAD SECHREST & MINICK P.C., PO BOX 50784, DALLAS, TX, 75201, US

(73) Assignee: Nano-Proprietary, Inc., Austin, TX (US)

(21) Appl. No.: 11/174,853

(22) Filed: Jul. 5, 2005

Related U.S. Application Data
(60) Provisional application No. 60/585,776, filed on Jul. 6, 2004.

(51) Int. Cl. B05D 1/12; B05D 5/00; B05D 7/00; B05D 1/40

(52) U.S. Cl. 427/180; 427/421.1; 427/240; 427/256; 427/430.1; 427/429; 427/331

(57) ABSTRACT

An industrial scale method for patterning nanoparticle emitters for use as cathodes in a display device is disclosed. The low temperature method can be practiced in high volume applications, with good uniformity of the resulting display device. The method steps involve deposition of CNT emitter material over an entire surface of a prefabricated composite structure, and subsequent removal of the CNT emitter material from unwanted portions of the surface using physical methods.

### CROSS-REFERENCE TO RELATED APPLICATIONS

The present invention claims priority under 35 U.S.C. 119(e) to U.S. Provisional Patent Application Ser. No. 60/585,776.

### TECHNICAL FIELD

The present invention relates in general to field emission, and in particular, to nanoparticles, such as carbon nanotubes, used for field emission applications.

### BACKGROUND INFORMATION

Carbon nanotubes (CNTs) are being investigated by a number of companies and institutions because of their extraordinary physical, chemical, electronic, and mechanical properties (Walt A. de Heer, “Nanotubes and the Pursuit of Applications,” MRS Bulletin 29(4), pp. 281-285 (2004)). They can be used as excellent cold electron sources for many applications, such as displays, microwave sources, x-ray tubes, and many other applications, because of their excellent field emission properties and chemical inertness, which enables a very stable, low voltage operation over a long lifetime (Zvi Yaniv, “The status of the carbon electron emitting films for display and microelectronic applications,” The International Display Manufacturing Conference, Jan. 29-31, 2002, Seoul, Korea).

In many cases, carbon nanotube emitters need to be deposited onto select regions of the substrate in order to operate under matrix-addressable conditions. For carbon nanotube field emission display applications, the pixel size of the CNTs may be as small as ˜300 microns in order to make high resolution displays. One can pattern such small dimensions of catalyst thin-films, such as Ni, Co, and Fe, onto the substrate by photolithography techniques; chemical vapor deposition (CVD) is then utilized to grow the CNTs at over 500° C. (Z. F. Ren, Z. P. Huang, J. W. Xu et al., “Synthesis of large arrays of well-aligned carbon nanotube on glass,” Science 282, pp. 1105-1107 (1998)). However, the CVD process is not suited for growing CNTs over large areas, because the high uniformity required for display applications is very difficult to achieve. CVD growth of CNTs also requires a high process temperature (over 500° C.), eliminating the use of low cost substrates, such as soda-lime glass.

Other methods include printing or spraying CNTs onto the selected regions of the conductive electrode line-patterned substrate. CNTs can be screen printed through a patterned mesh screen if they are mixed with a binder, epoxy, or other required additives (D. S. Chung, W. B. Choi, J. H. Kang et al., “Field emission from 4.5 in. single-walled and multiwalled carbon nanotube films,” J. Vac. Sci. Technol. B18(2), pp. 1054-1058 (2000)). CNTs can be sprayed onto a substrate through a shadow mask if they are mixed with a solvent such as IPA, acetone, or water (D. S. Mao, R. L. Fink, G. Monty et al., “New CNT composites for FEDs that do not require activation,” Proceedings of the Ninth International Display Workshops, Hiroshima, Japan, p. 1415, Dec. 4-6, 2002). In these methods, the deflection of either the patterned mesh screen or the shadow mask will make it difficult to align the CNT coating onto the electrode line-patterned substrate over a large area. For example, many display applications may require 40-100 inch diagonal plates. The application of photosensitive paste, including CNTs, and a subsequent back-side UV light exposure through the holes of the a-Si mask layer to form CNT emitters has been documented (J. E. Jung, J. H Choi, Y. J. Park et al., “Development of triode-type carbon nanotube field emitter array with suppression of diode emission by forming electroplated Ni wall structure,” J. Vac. Sci. Technol. B21(1), pp. 375-381 (2003)). However, photosensitive materials are very expensive and the process demands specific optical materials on the backside of the substrate. This results in a very complicated process that is very difficult to manage over a large area.

All of these problems impede the various field emission applications of CNTs. Therefore, there is an important need in the art for a low temperature method of applying CNT emitters to specific regions on a surface which is cost effective, and does not degrade the properties of the CNT cathode material.

### SUMMARY OF THE INVENTION

The present invention addresses the foregoing need by providing a low temperature method for patterning CNT emitters over a large scale surface. The present invention can be practiced in high volume industrial applications, with good uniformity of the resulting display device. The present invention involves deposition of CNT emitter material over an entire surface of a prefabricated composite structure, and subsequent removal of the CNT emitter material from unwanted portions of the surface using physical methods.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1A-1D illustrate a schematic diagram of a cross-sectional view of a CNT deposition process and resulting composite structure in accordance with one embodiment of the present invention;

FIG. 2 illustrates a schematic diagram of open pixels after an insulating overcoat deposition in accordance with one embodiment of the present invention;

FIG. 3 illustrates a schematic diagram of a cleaning process in accordance with one embodiment of the present invention;

FIGS. 4A-4C are photographs of optical microscope images of composite structures as shown in FIGS. 1B-1D;

FIG. 5 illustrates a portion of a field emission display made using a cathode in a diode configuration;

FIG. 6 illustrates an I-V curve from data collected from a sample in accordance with one embodiment of the present invention;

FIG. 7 is a photograph of field emission from a sample in accordance with one embodiment of the present invention;

FIG. 8 illustrates an I-V curve from data collected from a sample in accordance with one embodiment of the present invention;

FIG. 9 is a photograph of field emission from a sample in accordance with one embodiment of the present invention;

FIG. 10 is a photograph of field emission from a sample in accordance with one embodiment of the present invention; and

FIG. 11 illustrates a data processing system configured in accordance with one embodiment of the present invention.

### DETAILED DESCRIPTION

In the following description, numerous specific details are set forth such as specific substrate materials to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

The present invention provides a low temperature method for patterning CNT emitters over a large scale surface. The present invention can be practiced at an industrial scale with good uniformity of the resulting display device.

For the source of CNTs, purified single wall carbon nanotubes, or SWNTs, (obtained from Carbon Nanotechnologies, Inc., Houston, Tex., USA) were utilized. The SWNTs were 1˜2 nm in diameter and 1˜20 μm in length. Either purified, unpurified single wall, double wall or multiwall carbon nanotubes, carbon fibers or other kinds of nanotubes and nanowires from other sources can also be used to practice embodiments of the present invention.

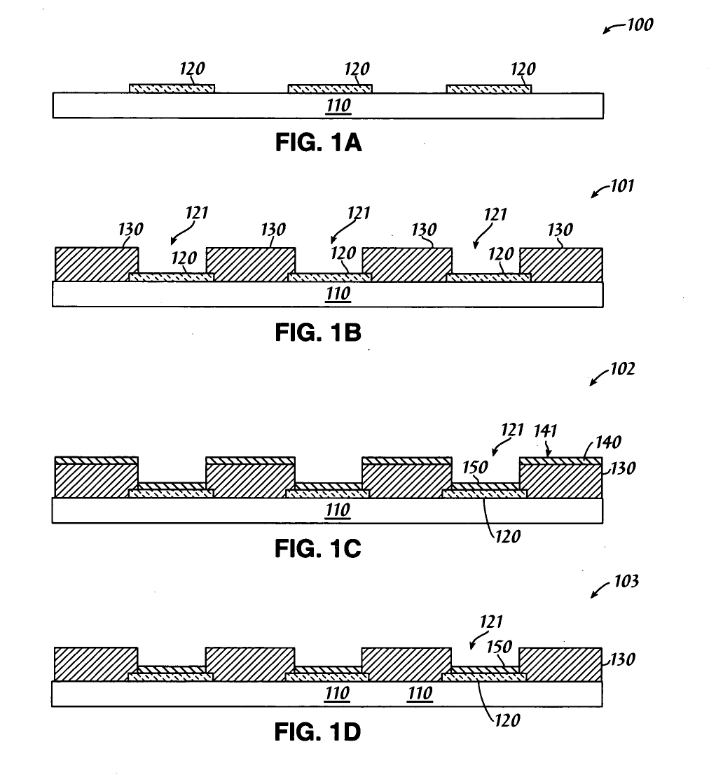

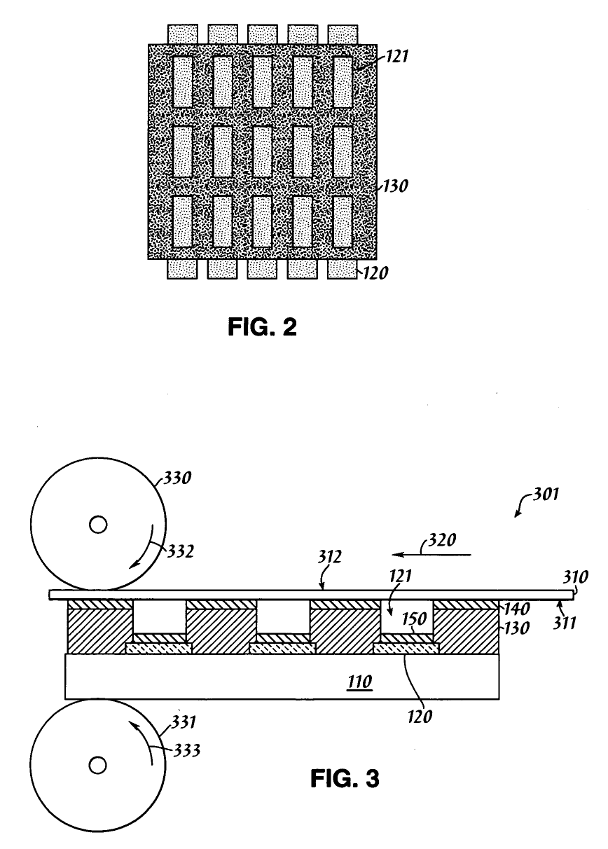

FIGS. 1A-1D illustrate a schematic diagram of a cross-sectional view of the structure of the composite device and CNT deposition process 100, 101, 102, 103 in accordance with one embodiment of the present invention. First, a 2.5 mm thick 12 inch×12 inch size glass plate was chosen as the substrate 110. Any other kind of insulating substrates, such as ceramic plates, can be used. Then, in one example, a layer of Ag electrode lines 120 were patterned onto it using a screen printing process 100. In one example of the present invention, the width of the Ag electrode lines 120 was 400 μm, while the gap between the nearest Ag lines was 125 μm. In another example, a total of 480 Ag electrode lines 120 were patterned 100 on the substrate 110. Silver thick paste (acquired from Dupont #7713) was the material used to deposit 100 the Ag electrode lines 120. The resulting composite structure as illustrated in FIG. 1A was fired at 520° C. for 30 min. to remove the organic solvents in the Ag paste 120. In one example method, the thickness of the Ag electrode lines 120 was 6 microns. Next, a 50 micron insulating overcoat 130 was covered 101 onto the surface of the composite structure of FIG. 1A, leaving patterned open pixels 121 on the Ag electrode lines 120, as illustrated in FIG. 1B. In this case, size of the pixels 121 was 340 μm×1015 μm, while the distance between the nearest two pixels on the same Ag electrode line 120 was 560 μm, and 225 μm between the nearest two Ag electrode lines 120. FIG. 2 illustrates the schematic diagram (top view) of the open pixels 121 on the Ag electrode lines 120 after the insulating overcoat 130 deposition 101. In the present example, the pixels 121 were patterned on a 10 inch×10 inch region with a total number of 480×160 pixels 121 in this region. The resulting composite structure, as shown in FIG. 1B, was fired at 520° C. for 30 min. after the insulating overcoat 130 was printed 101 on the substrate 110 and Ag lines 120.

FIG. 1C illustrates the deposition 102 of the CNTs 150, 140 onto the surface of the composite structure of FIG. 1B. In separate embodiments of the present invention, the CNTs 150, 140 were deposited 102 over the entire coated surface using spray and screen printing methods. The invention may be practiced in other embodiments which use methods such as electrophoresis deposition, dipping, screen printing, ink-jet printing, dispensing, spin-coating, brushing or a plurality of other techniques to deposit CNTs onto the surface of the composite structure of FIG. 1B.

In one embodiment of the current invention, deposition of the CNTs 102 is performed using a spray process over an area of 2 cm×2 cm, which contains a grid of 12×36 pixels 121. A simple ball mill, rotating at about 50˜60 revolutions per minute, was used to grind the CNT powder (obtained from Carbon Nanotechnologies Inc.) in order to disperse it, since the CNT powder contained many CNT clusters and bundles. In one instance, 1 g of CNTs along with 100 stainless steel 5 mm diameter balls used for grinding were mixed with 200˜300 ml IPA. This mixture was ground for 1˜14 days to sufficiently disperse the carbon nanotubes. In another instance, a surfactant or similar material may additionally be added to the mixture for improving dispersion of the CNTs.

Because CNTs easily clump together when grinding or stirring is stopped, an ultrasonic horn or bath is used to disperse them again in an IPA solution before spraying 102 them onto the composite structure as shown in FIG. 1C. In one method of the present invention, an airbrush was used to spray 102 CNTs 140, 150 onto the surface of the composite structure as shown in FIG. 1C. To improve coating uniformity and dispersion, more IPA can be added to the solution before spraying. In one case, the spraying solution contained about 0.2° g CNTs dispersed in 1000 ml of IPA. In one example method, the composite structure as shown in FIG. 1C was heated to ˜70° C. on both the front and back side during spraying to evaporate the IPA quickly. In one instance, spraying 102 was performed repeatedly, coating the entire surface of the composite structure as shown in FIG. 1C with dozens of layers of spray solution. In one sample, the applied thickness of the CNT layer 104, 105 was about 2˜5 μm.

As shown by the resulting structure in FIG. 1D, after the CNTs 140, 150 were deposited 102 onto the whole surface of the composite structure as shown in FIG. 1B, a cleaning process 103 was used to remove the CNT layer 140 on the top of the insulating overcoat 130. A tape 310 (an adhesive layer on one side 311 and a plastic layer on the other side 312) was used as a carrier medium to remove the CNT layer 140. Referring to FIG. 3, the tape 310 was applied to the CNT coated composite structure in FIG. 1C using a laminating process 301. The lamination process 301 may be implemented with two parallel rollers 330, 331 in contact with the tape 310 and the composite structure shown in FIG. 1C. The roller 330, rotating clockwise 332, is in contact with the tape surface 312 on one side of the composite structure, while roller 331, rotating counterclockwise 333, is in contact with the bottom of the glass substrate 110 on the other side of the composite structure, which is pulled towards 320 the rollers in FIG. 3. When the composite structure was passed through the two rollers from one side to the other side, a force was applied to the tape 310 and uniformly laminated the tape onto the composite structure. Then, the tape 310 was peeled away along with the CNT material 140 that was bonded to the tape 310. In one example method, clear tape 310 (3M #336) was used to strip away the CNT layer 140. Care may be taken to ensure that there is no air between the tape 310 and the surface of the CNT coating 141, or that no bubbles or blisters form in the tape 310. In other example methods of the present invention, the tape lamination and removal process may be repeated as required.

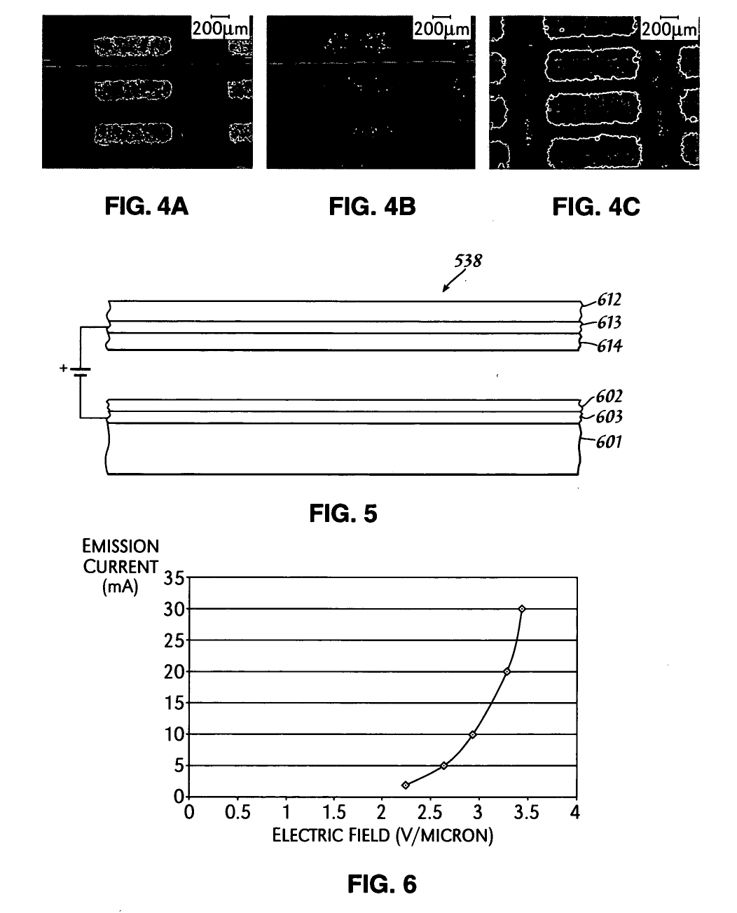

FIG. 4A is an optical microscopy photograph of the top view of the composite structure as shown in FIG. 1B, before the CNTs 140, 150 are applied. FIG. 4B is an optical microscopy photograph of the top view of the composite structure as shown in FIG. 1C after the CNT coating 140, 150 has been applied. FIG. 4C is an optical microscopy photograph of the top view of the composite structure as shown in FIG. 1D after stripping with tape 310. In FIG. 4A, the open pixels 121 (white areas) are clearly visible. The pixels 121 appear black after the CNT deposition 102, as can be seen in FIG. 4B. The removal of the undesired CNTs 140 by the tape processing is shown in FIG. 4C. In FIG. 4C, the black areas represent CNTs in the pixel 150 and electrode lines, whereas the white areas represent the surface 141 where the tape was laminated onto. FIG. 4C illustrates that the CNTs material 150 in the pixel wells 121 was not removed.

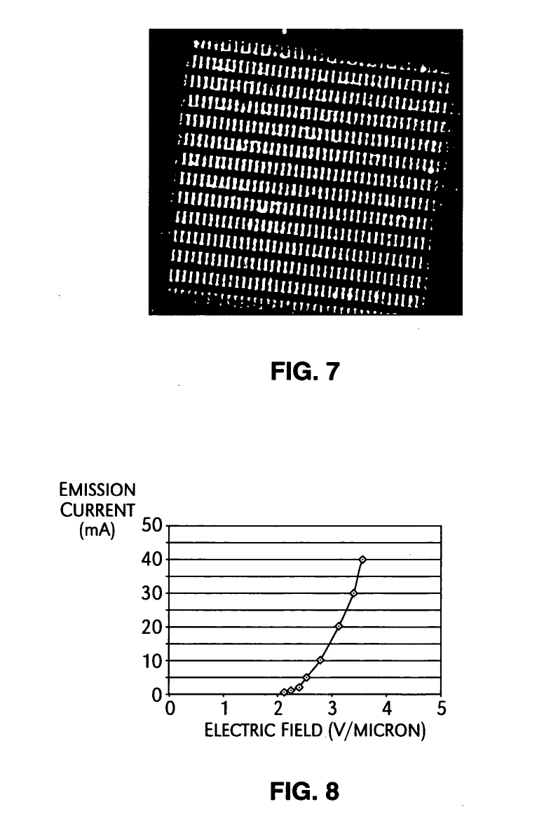

The field emission properties of the composite structure shown in FIG. 1D were tested by mounting the sample with a phosphor screen in a diode configuration, as shown in FIG. 5, with a gap of about 0.5 mm between the anode and cathode. The test assembly was placed in a vacuum chamber and pumped to 10⁻⁷ Torr. The electrical properties of the cathode were then measured by applying a negative, pulsed voltage (AC) to the cathode while holding the anode at ground potential, and measuring the current at the anode. In another method, a DC potential may also be used for field emission testing. A graph of the emission current, mA vs. electric field, V/μm for the samples on which data was collected is shown in FIG. 6. FIG. 7 is a photograph of a field emission image of a sample at an emission current of 30 mA. Using the methods of the present invention, the field emission image of every pixel is well defined, as illustrated in FIG. 7.

As illustrated in FIG. 1B, the CNTs were deposited 102 on the composite structure using a screen printing process. For the screen printing methods, 355-mesh screen was used to print the CNT paste onto the substrate with a controlled thickness. The screen was not patterned to match the patterned open pixels of the substrate, rather the screen was a single pixel mesh screen, such that the CNTs may be printed over the whole surface on the composite structure as shown in FIG. 1B.

The CNT paste used for screen printing was made by mixing the CNT powder with vehicle (organic solvent, Daejoo Fine Chemical Co.), glass frit (binder, Daejoo Fine Chemical Co.), and thinner (organic solvent, DuPont) to adjust the viscosity of the paste. Various compositions and recipes may be practiced for mixing the CNT paste in other examples of the present invention.

Next, the CNT paste was printed onto the substrate over a region of about 5 cm×5 cm, which corresponds to 24×72 pixels in this region. Then the sample was fired at 450° C. for 20 min. to remove the organic solvent. Various firing temperatures and durations may be practiced with the current invention. In the present example method, the thickness of the CNT coating was around 4-5 μm.

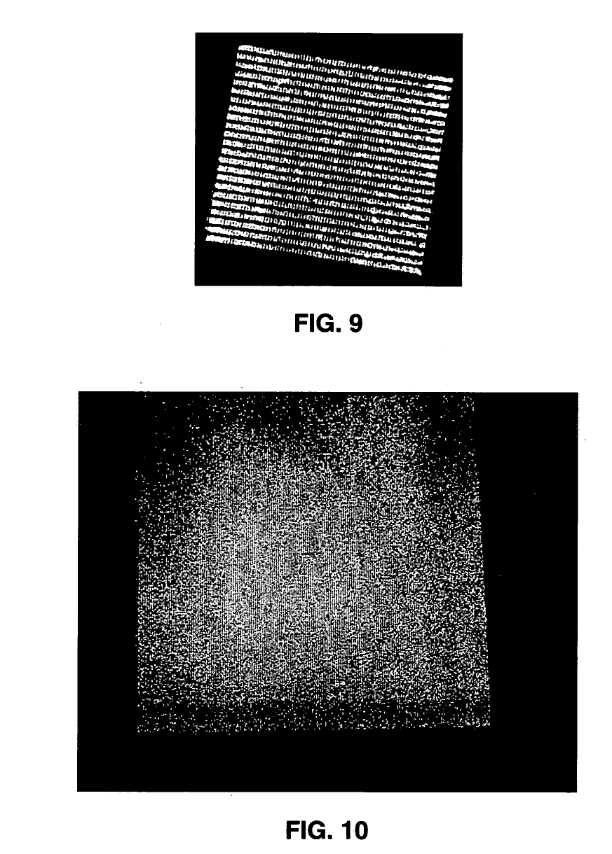

Next, the CNT layer 140 on the surface of the overcoat insulating layer 130 applied by screen printing was cleaned by the same taping process 301 as mentioned previously for spray coating. The field emission properties of the screen printed sample were then tested according to the same configuration as mentioned previously for spray coating, shown in FIG. 5. FIG. 8 shows the graph of the emission current, mA vs. electric field, V/μ, and FIG. 9 is a photograph of the field emission image at 30 mA emission current of the sample which was screen printed.

In another embodiment of the present invention, the CNT paste was also screen printed onto the composite structure as shown in FIG. 1B with an area of 10 inch×10 inch. After the firing and tape cleaning process according to the methods of the previous samples, the field emission properties of this sample were also tested using the methods of the previous samples. The field emission was observed to be very uniform, as illustrated in FIG. 9, which is a photograph of an area of 10 inch×10 inch at 120 mA current. The dark area in this image is attributed to the nonuniformity of the phosphor screen.

In other examples, other methods or combinations of methods of patterning the carbon nanotube cold emitters may be implemented. After the CNT layer was deposited over the entire surface of the composite structure as shown in FIG. 1B, the CNT emitters were patterned by removing the CNTs from undesired regions of the surface of the composite structure as shown in FIG. 1B. Depending on the features the composite structure on which the CNTs are deposited, the CNTs may be patterned by the taping process previously described. Other methods for patterning the CNTs on the composite structure on which the CNTs are deposited include methods such as sandblasting or beadblasting to remove the unwanted CNT layer 140 from the surface. In other examples, the composite structure on which the CNTs are patterned may be different.

The methods of the present invention represent practical and efficient low temperature processes, which may be practiced in high volume, industrial scale for achieving a very good uniformity of the resulting CNT cathode emitters.

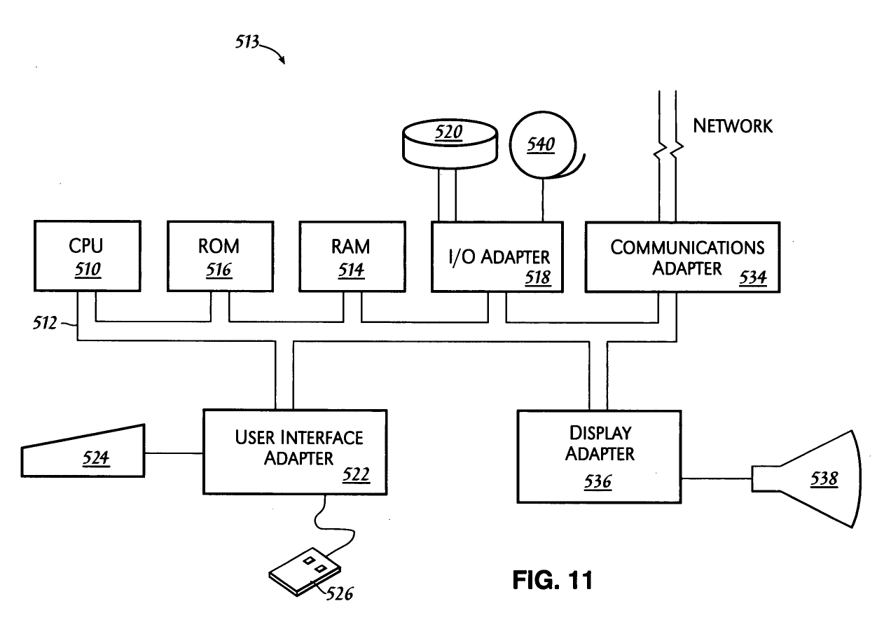

A representative hardware environment for practicing the present invention is depicted in FIG. 11, which illustrates an exemplary hardware configuration of data processing system 513 in accordance with the subject invention having central processing unit (CPU) 510, such as a conventional microprocessor, and a number of other units interconnected via system bus 512. Data processing system 513 includes random access memory (RAM) 514, read only memory (ROM) 516, and input/output (I/O) adapter 518 for connecting peripheral devices such as disk units 520 and tape drives 540 to bus 512, user interface adapter 522 for connecting keyboard 524, mouse 526, and/or other user interface devices such as a touch screen device (not shown) to bus 512, communication adapter 534 for connecting data processing system 513 to a data processing network, and display adapter 536 for connecting bus 512 to display device 538. CPU 510 may include other circuitry not shown herein, which will include circuitry commonly found within a microprocessor, e.g., execution unit, bus interface unit, arithmetic logic unit, etc. CPU 510 may also reside on a single integrated circuit.

FIG. 5 illustrates a portion of a field emission display 538 made using a cathode in a diode configuration, such as created above. Included with the cathode is a conductive layer 602. The anode may be comprised of a glass substrate 612, and indium tin layer 613, and a cathodoluminescent layer 614. An electrical field is set up between the anode and the cathode. Such a display 538 could be utilized within a data processing system 513, such as illustrated with respect to FIG. 11.

What is claimed is:

1. A method of patterning nanoparticle field emitters, comprising the steps of:
providing a structure on which to pattern the nanoparticle field emitters;
depositing a uniform layer of nanoparticle material over the entire surface of said structure; and
removing said layer of nanoparticle material from undesired regions of said surface of said structure using physical methods.

2. The method recited in claim 1, wherein said depositing is performed by a process chosen from the group comprising:
spraying; screen printing; electrophoresis deposition; dipping;
ink-jet printing; dispensing; spin-coating; brushing; and
any combination thereof.

3. The method recited in claim 1, wherein said nanoparticle material comprises material chosen from the group comprising:
single wall carbon nanotubes; double wall carbon nanotubes;
multiwall carbon nanotubes; buckytubes; carbon fibrils;
chemically modified carbon nanotubes; derivatized carbon nanotubes;
metallic carbon nanotubes; semiconducting carbon nanotubes;
metallized carbon nanotubes; graphite; carbon whiskers; and
any combination thereof.

4. The method recited in claim 1, wherein said nanoparticle material comprises particles chosen from the group comprising:
spherical particles; dish-shaped particles; lamellar particles; rod-like particles; metallic particles; semiconducting particles; polymeric particles; ceramic particles; dielectric particles; clay particles; fibers; nanoparticles; and any combination thereof.

5. The method recited in claim 1, wherein said layer of nanoparticle material has a thickness which ranges from about 10 nm to about 1 mm.

6. The method recited in claim 1, wherein said structure and said nanoparticle material are not exposed to temperatures higher than about 150° C.

7. The method recited in claim 1, wherein said removing is performed by a physical method chosen from the group comprising:
taping; sandblasting; beadblasting; jetting; grinding; polishing; mechanical etching; scraping; ablation; erosion; and
any combination thereof.

8. The method recited in claim 1, wherein said structure is formed as a solid-state composite structure with individual layers, using a process to apply the individual layers comprising the steps of:
providing an insulating glass or ceramic substrate; and
forming an electrically conducting material deposited as a patterned layer on the surface of said substrate.

9. The method as recited in claim 8, further comprising the step of:
forming an electrically insulating material deposited as a patterned layer on the surface of said substrate over said patterned layer of said electrically conducting material.

10. The method recited in claim 8, wherein the patterning of said electrically conducting material is performed with a standard screen printing process.
